(19) United States
(12) Patent Application Publication
(10) Pub. No.: US 2023/0030966 A1
(43) Pub. Date: Feb. 2, 2023

(54) OMNICHANNEL DATA ANALYSIS

(71) Applicant: Big Co, Inc., Austin, TX (US)

(72) Inventors: Chris Tranquill, Austin, TX (US); Jeff Yentis, Austin, TX (US); Ryan Studer, Austin, TX (US)

(73) Assignee: Khoros, LLC, Austin, TX (US)

(21) Appl. No.: 17/390,968

(22) Filed: Jul. 31, 2021

(51) Int. Cl. G06Q 30/02; G06F 16/23

(52) U.S. Cl. CPC G06Q 30/0201; G06F 16/2365

(57) ABSTRACT

Techniques for omnichannel data analysis are described, including receiving a sub-atomic interaction set at an omnichannel data analysis engine, transforming the sub-atomic interaction set from a first object to a second object associated with a data cohort, modifying an attribute of the second object to configure the second object to be used in sub-atomic interaction convergence, identifying related interactions from the sub-atomic interaction set to be combined into an atomic interaction, aligning a data attribute parsed from the atomic interaction to identify interaction attributes from data channels monitored by the omnichannel data analysis engine, conforming the data attribute to a unified atomic interaction object definition, evaluating the atomic interaction and the data attribute, extracting a portion of the second object to derive another attribute, performing enrichment set analysis on the second object and data cohort, and generating an output of the analysis.

### FIELD

The present inventive subject matter relates generally to computer science, data science, data analytics, computer software, data structures, and data and algorithmic analysis using machine learning techniques. More specifically, techniques for omnichannel data analysis are described.

### BACKGROUND

As online purchasing of goods and services activities continue to increase, there are numerous problems arising with conventional solutions such as platforms that manage activities such as searching, selling, purchasing, returning, and getting customer support. Data transactions are occurring at ever-increasing rates and volumes and conventional solutions for analyzing these tremendous amounts of data are becoming, likewise, more difficult. For example, conventional customer support solutions are often challenged technically due to the numerous and varied communication channels that may be used by a consumer to communicate with a retailer, good or service provider, business, enterprise, or organization (e.g., for-profit and not-for-profit). Various social media channels and networks, websites, text messaging, telephone, smartphone, cellular phone, and other communication media and channels typically used by conventional customer support solutions providers provide multiple and useful ways to connect with consumers, but the data generated from transactional events (e.g., phone calls, electronic mail (hereafter “email”), text messages, chat, SMS, IRC, video calls, augmented reality (AR), and virtual reality (VR)-based communication applications, customer relationship management (CRM) applications, surveys, product reviews, online forums, among others, without restriction or limitation) are neither consistent nor unifying in the handling of data resulting from these transactions. Further, conventional solutions do not provide or apply useful analytical technologies to this data that can help businesses, enterprises, organizations, and the key decisionmakers and stakeholders within, make efficient, accurate, timely, tactical, or strategic decisions to improve transactions and financial performance, which can be dramatically affected by how well such transactions with consumers are handled. Given the sheer volume and often incongruous data types, schemas, formats, and languages involved in these transactions, conventional solutions are unable to improve customer experience-related software (e.g., applications and platforms) despite the dramatic rise in online transactional events and the increasing spread of computing resources and power (e.g., desktop, laptop, server-based, mobile, and the like). Conventional solutions for providing customer-oriented support, regardless of whether for consumer, commercial, or enterprise-related goods and services, can significantly impact not only the experience of a business' customer, but also fundamental business decisions, which are often inefficient or inaccurate due to either a lack of accurately analyzed data and inaccurate presentations of business data that can lead to inaccurate or erroneous business decisions.

Using conventional solutions to manage a customer environment or experience is not only fraught with inaccuracies and inefficiencies, but due to increasingly massive amounts of data being analyzed, accurate and efficient decisions that can substantially affect a business, its products and/or services, and its customers are challenging. For example, many key decisionmakers within an organization such as a Chief Executive Officer, Chief Financial Officer, vice presidents, directors, product managers, and many other key decisionmakers at many levels throughout an organization often see data pertinent to their immediate level, but not an entire organization. Additionally, key decisionmakers may only see data relevant at a micro or macro-level, which lessens the efficacy and applicability of decisions made. Conversely, conventional solutions do not provide granular, detailed data and information that can be analyzed down to individual customer, account, or transaction levels. Thus, while decisionmakers are making decisions that can significantly impact an organization, the data and information underlying these decisions are limited in transparency and applicability to all levels of a business, enterprise, or organization.

Thus, what is needed is a solution for analyzing data from data transactions over various communication channels without the limitations of conventional techniques.

### BRIEF DESCRIPTION OF THE DRAWINGS

Various embodiments or examples (“examples”) are disclosed in the following detailed description and the accompanying drawings:

FIG. 1A illustrates an exemplary system for omnichannel data analysis;

FIG. 1B illustrates an exemplary ingestion pipeline module for omnichannel data analysis;

FIG. 1C illustrates an exemplary analytics/AI pipeline module for omnichannel data analysis;

FIG. 1D illustrates an exemplary user interface module for omnichannel data analysis;

FIG. 1E illustrates an exemplary insight distribution module for omnichannel data analysis;

FIG. 2 illustrates an exemplary system topology for omnichannel data analysis;

FIG. 3 illustrates an exemplary process for omnichannel data analysis;

FIG. 4 illustrates another exemplary process for omnichannel data analysis; and

FIG. 5 illustrates an exemplary computing system suitable for omnichannel data analysis.

### DETAILED DESCRIPTION

Various embodiments or examples may be implemented in numerous ways, including as a system, a process, an apparatus, a user interface, or a series of program code or instructions on a computer readable medium such as a storage medium or a computer network including program instructions that are sent over optical, electronic, electrical, chemical, wired, or wireless communication links. In general, individual operations or sub-operations of disclosed processes may be performed in an arbitrary order, unless otherwise provided in the claims.

A detailed description of one or more examples is provided below along with accompanying figures. This detailed description is provided in connection with various examples, but is not limited to any particular example. The scope is limited only by the claims and numerous alternatives, modifications, and equivalents. Numerous specific details are set forth in the following description in order to provide a thorough understanding. These details are provided for the purpose of illustrating various examples and the described techniques may be practiced according to the claims without some or all of these specific details. For clarity, technical material that is known in the technical fields and related to the examples has not been described in detail to avoid unnecessarily obscuring the description or providing unnecessary details that may be already known to those of ordinary skill in the art.

As used herein, “system” may refer to or include the description of a computer, network, or distributed computing system, topology, or architecture using various computing resources that are configured to provide computing features, functions, processes, elements, components, or parts, without any particular limitation as to the type, make, manufacturer, developer, provider, configuration, programming or formatting language (e.g., JAVA®, JAVASCRIPT®, and others, without limitation or restriction), service, class, resource, specification, protocol, or other computing or network attributes. As used herein, “software” or “application” may also be used interchangeably or synonymously with, or refer to a computer program, software, program, firmware, or any other term that may be used to describe, reference, or refer to a logical set of instructions that, when executed, performs a function or set of functions within a computing system or machine, regardless of whether physical, logical, or virtual and without restriction or limitation to any particular implementation, design, configuration, instance, or state. Further, “platform” may refer to any type of computer hardware (hereafter “hardware”) and/or software using, hosted on, served from, or otherwise implemented on one or more local, remote, and/or distributed data networks such as the Internet, one or more computing clouds (hereafter “cloud”), or others. Data networks (including computing clouds) may be implemented using various types of standalone, aggregated, or logically-grouped computing resources (e.g., computers, clients, servers, tablets, notebooks, smart phones, cell phones, mobile computing platforms or tablets, and the like) to provide a hosted environment for an application, software platform, operating system, software-as-a-service (i.e., “SaaS”), platform-as-a-service, hosted, or other computing/programming/formatting environments, such as those described herein, without restriction or limitation to any particular implementation, design, configuration, instance, version, build, or state. Distributed resources such as cloud computing networks (also referred to interchangeably as “computing clouds,” “storage clouds,” “cloud networks,” or, simply, “clouds,” without restriction or limitation to any particular implementation, design, configuration, instance, version, build, or state) may be used for processing and/or storage of varying quantities, types, structures, and formats of data, without restriction or limitation to any particular implementation, design, or configuration. In the drawings provided herewith, the relative sizes and shapes do not convey any limitations, restrictions, requirements, or dimensional constraints unless otherwise specified in the description and are provided for purposes of illustration only to display processes, data, data flow chart, application or program architecture or other symbols, as described in this specification.

As described herein, structured and unstructured data may be stored in various types of data structures including, but not limited to databases, repositories, warehouses, datalakes, lakehouses, data stores, and other data structures and facilities configured to manage, store, retrieve, process calls for/to, copy, modify, or delete data or sets of data (i.e., “datasets”) in various computer programming languages and formats (e.g., structured, unstructured, binary, and others) in accordance with various types of structured and unstructured database schemas and languages such as SQL®, MySQL®, NoSQL™, DynamoDB™, R, or others, such as those developed by proprietary and open source providers like Amazon® Web Services, Inc. of Seattle, Wash., Microsoft®, Oracle®, Google®, Salesforce.com, Inc., and others, without limitation or restriction to any particular schema, instance, or implementation. Further, references to databases, data structures, or any type of data storage facility may include any embodiment as a local, remote, distributed, networked, cloud-based, or combined implementation thereof, without limitation or restriction. In some examples, data may be formatted and transmitted (i.e., transferred over one or more data communication protocols) between computing resources using various types of wired and wireless data communication and transfer protocols such as Hypertext Transfer Protocol (HTTP), Transmission Control Protocol (TCP)/Internet Protocol (IP), Internet Relay Chat (IRC), SMS, text messaging, instant messaging (IM), WiFi, WiMax, or others, without limitation. Further, as described herein, disclosed processes implemented as software may be programmed using JAVA®, JAVASCRIPT®, Scala, Perl, Python™, XML, HTML, and other data formats and programming languages, without limitation. As used herein, references to layers of an application architecture (e.g., application layer or data layer) may refer to a stacked layer application architecture designed and configured using models such as the Open Systems Interconnect (OSI) model or others.

The described techniques may be implemented as a software-based application, platform, or schema. In some examples, machine learning, deep learning, neural networks, and other types of computing, processing, and analytical algorithms such as those used in various computer science-related fields may be used to implement techniques related to “artificial intelligence” (i.e., “AI”). While there is no particular dependency to a given type of algorithm (e.g., machine learning, deep learning, neural networks, intelligent agents, or any other type of algorithm that, through the use of computing machines, attempts to simulate or mimic certain attributes of natural intelligence such as cognitive problem solving, without limitation or restriction), there is likewise no requirement that only a single instance or type of a given algorithm be used in the descriptions that follow. Algorithms may be untrained or trained using model data, external data, internal data, or other sources of data that may be used to improve the accuracy of calculations performed to generate output data for use in applications, systems, or platforms in data communication with software module or engine-based implementations. The described techniques within this Detailed Description are not limited in implementation, design, function, operation, structure, configuration, specification, or other aspects and may be varied without limitation. The size, shape, quantity, configuration, function, or structure of the elements shown in the various drawings may be varied and are not limited to any specific implementations shown, which are provided for exemplary purposes of illustration and are not intended to be limiting.

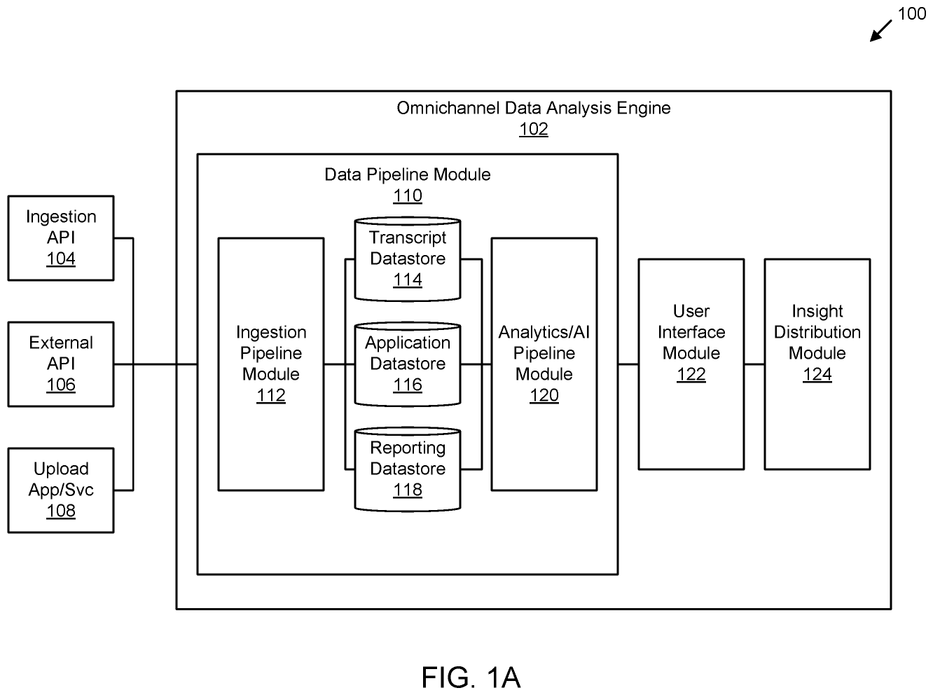

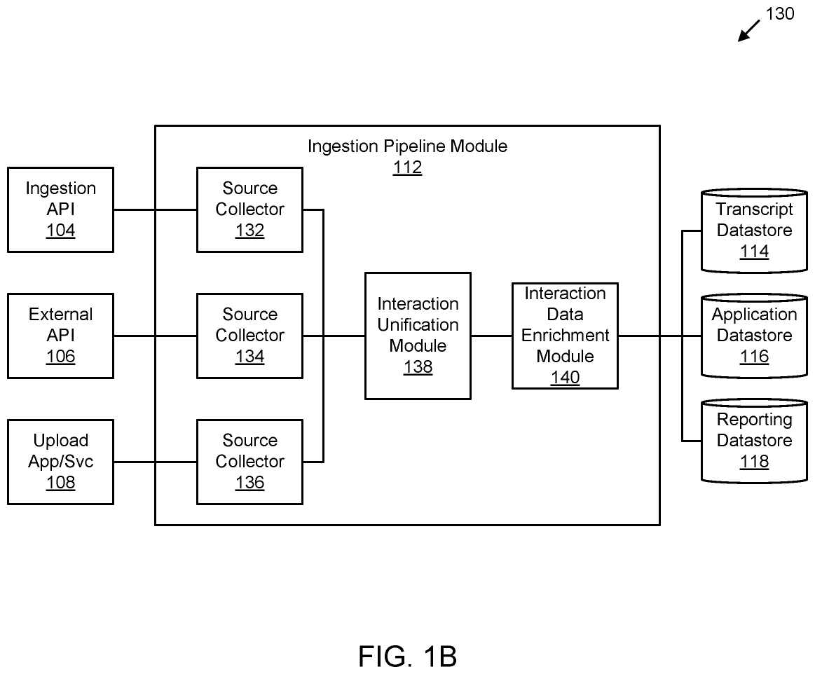

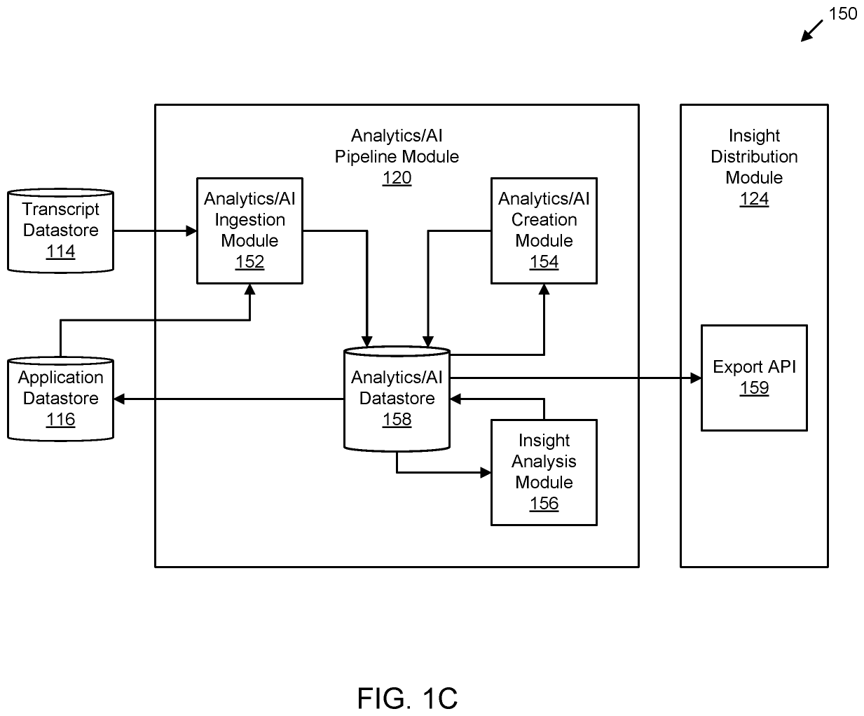

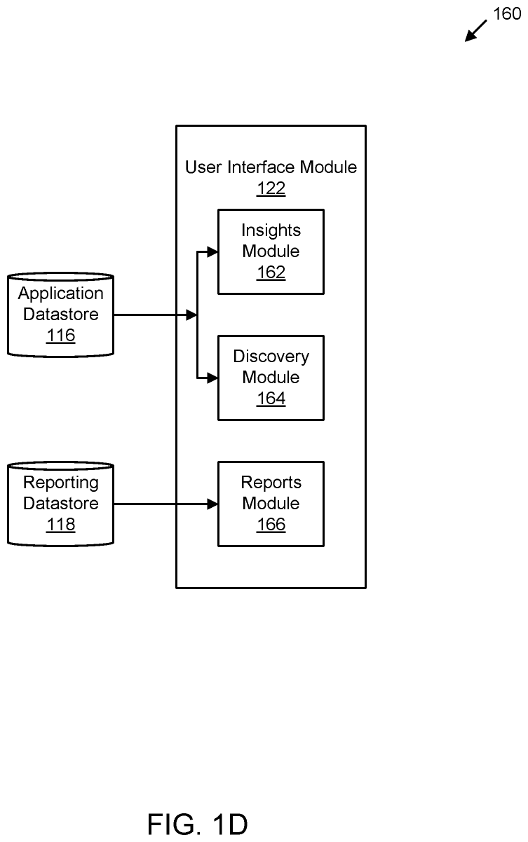

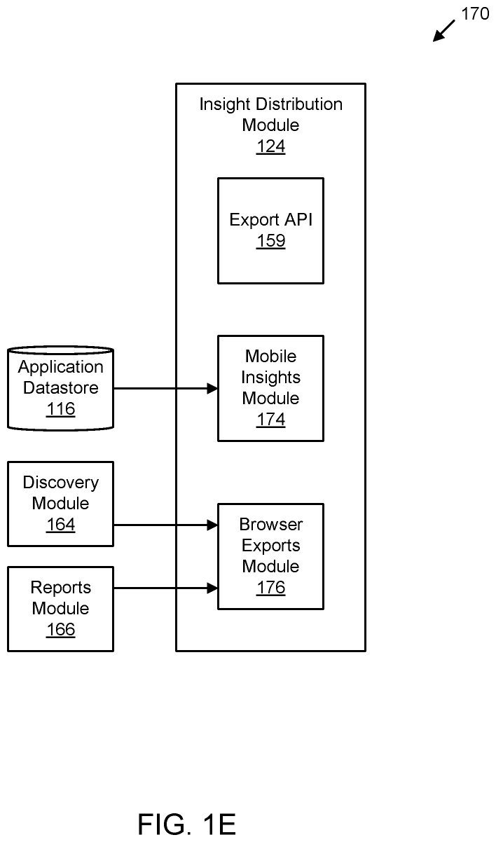

FIG. 1A illustrates an exemplary system for omnichannel data analysis. Here, system 100 includes omnichannel data analysis engine 102, ingestion application programming interface (hereafter “API”) 104, external API 106, upload application/service 108, data pipeline module 110, ingestion pipeline module 112, transcript data store 114, application datastore 116, reporting datastore 118, analytics/AI pipeline module 120, user interface module 122, and insight distribution module 124. In some examples, omnichannel data analysis engine 102 may be configured to receive data over ingestion API 104, external API 106, and/or upload application/service 108. As shown, ingestion API 104, external API 106, and/or upload application/service 108 may be configured to receive any form, format, or type (e.g., structured, unstructured, binary, or others) of data for further processing and analysis by omnichannel data analysis engine 102. As used herein and throughout this Detailed Description, “omnichannel” refers to any type of data communication channel (e.g., digital, analog, or binary) over which data may transferred by, between, and with omnichannel data analysis engine 102. For example, data may be transferred between an analog phone that, when processed through a digital codec, provides digital data to omnichannel data analysis engine 102, although the originating source data may have been an analog voice call. Conversely, a mobile computing device may access a social network and initiate an online (i.e., digital) chat, conversation, or other transaction with a customer contact or support center (e.g., on-premises, hosted, CCaaS (i.e., Customer-Contact-as-a-Service), CPaaS (i.e., Communications-Platform-as-a-Service), digital-first solutions, and others, without restriction or limitation) business selling a particular type of good or service. Further, Data received by ingestion API 104, external API 106, and/or upload application/service 108 may be input to data pipeline module 110, which manages data ingestion by omnichannel data analysis engine 102 and performs initial data handling and processing functions to transform input data (i.e., received at ingestion API 104, external API 106, and/or upload application/service 108) for further processing by analytics/AI pipeline module 120 and storage in one or more of datastores 114-118 (e.g., transcript datastore 114, application datastore 116, reporting datastore 118). Once ingested and initial transformation operations are performed, analytics/AI pipeline module 120 may be configured to perform analysis by applying various types of algorithms, including, but not limited to machine learning, deep learning, neural networks, or other types of “AI”-related algorithmic processing techniques on transformed data from ingestion pipeline module 112.

In some examples, analyzed and transformed data from analytics/AI pipeline module 120 may then be transferred to user interface module 122. As shown, user interface module 122 may be configured to use analyzed data (not shown) from analytics/AI pipeline module 120 to generate visualizations (i.e., render displays, screens, and other graphical, visual, or multimedia information for consumption by client devices in data communication with omnichannel data analysis engine 102). In other examples, user interface module 122 may also be configured to perform other or extended analyses on transformed and analyzed data from data pipeline module 110. For example, user interface module 122 may perform operations on transformed, analyzed data from user interface module 122 to identify “insights” (as used herein, “insights” may refer to any type of resultant data generated by evaluating, algorithmically or otherwise, transformed and analysed data input to data pipeline module 110), which may be subsequently transferred to insight distribution module 124. In some examples, insight distribution module 124 may be configured to receive resultant data from user interface module 124 to perform various types of formatting, programming, handling, or other operations in order to provide output from omnichannel data analysis engine 102 to, for example, client computing devices (e.g., desktop, laptop, cellular, server, or mobile computing devices, others, without limitation or restriction) on which insights may be reviewed, other data input to omnichannel data analysis engine 102, or other operations, without limitation or restriction. In other examples, omnichannel data analysis system 100 and the elements shown and described may be varied in structure, function, design, layout, order, quantity, size, shape, configuration, and implementation and are not limited to those presented, which are provided for purposes of exemplary description.

FIG. 1B illustrates an exemplary ingestion pipeline module for omnichannel data analysis. Here, ingestion system 130 includes ingestion API 104, external API 106, upload application/service 108, ingestion pipeline module 112, transcript datastore 114, application datastore 116, reporting datastore 118, source collectors 132-134, interaction unification module 138, and interaction data enrichment module 140. As used herein and throughout this Detailed Description, like-named and like-numbered elements may be configured, structured, and function similarly. Accordingly, API 104, external API 106, upload application/service 108, ingestion pipeline module 112, transcript datastore 114, application datastore 116, reporting datastore 118 are presented for purposes of illustration and description to present structures and functions similar to those presented above. As shown here, data may be ingested (e.g., input) to any of ingestion API 104, external API 106, and/or upload application/service 108 to be received by ingestion pipeline module 112 by source collectors 132-136.

In some examples, source collector modules 132-136 may be configured with various components implemented in software, as computer programs or applications, as local, remote, or distributed elements of a platform configured to perform omnichannel data analysis as described herein. For further explanation, “omnichannel” may refer to one or more communication channels of different data types, media, forms, formats, or other characteristics, but which may be analyzed together in a unified analytical environment such as those described in this Detailed Description. As used herein, source collectors 132-136 may be configured to receive media data containers (of any type, form, format, or structure), which then results in using data container extractors (not shown) to parse and identify media interactions, which may be in parts. In some examples, “media interactions” may refer to interactions that occur between a client computing or data device (e.g., analog, digital, binary) and omnichannel data analysis engine 102. Once media interactions have been parsed and identified from received media containers, business rules may be applied to transform the media interactions into sub-atomic interactions that may be output from source collectors 132-136 to interaction unification module 138 and converged into sub-atomic interactions. In some examples, sub-atomic interactions may be combined into atomic interactions (e.g., an entire conversation or data-generating event between a client computing device and a customer contact center or customer experience environment in data communication with omnichannel data analysis engine 102 (FIG. 1A).

In some examples, interaction unification module 138 may be configured to unify or converge sub-atomic interaction data sets into a “full interaction” between a client computing device and a customer contact center or customer experience environment in data communication with omnichannel data analysis engine 102 (FIG. 1A). Once unified, media full interaction data sets may undergo data attribute alignment, where data attributes of individual interaction sets are aligned in preparation for further parsing and analysis by, for example, analytics/AI pipeline module 120 using one or more machine learning, deep learning, neural networks, or AI-related algorithms. Further, data attributes and interactions are mapped to each other in order to generate data cohorts based on common and aligned data attributes. In other examples, labels may be assigned to data attributes.

Referring back to FIG. 1B, source collector modules 132-136 may be implemented with different and varying components. For example, source collector modules 132-136 may include components configured to perform functions and data operations such as data container extraction, transformation of data (by applying rules (e.g., business rules)), and data merges. In other words, ingested data may be extracted in data containers using, for example, a data extractor (not shown) implemented by one or more of source collectors 132-136. Ingested data may also be transformed from a received (e.g., at API 104, external API 106, upload application/service 108) form into another form, type, format, or the like by applying transformation rules such as business transformation rules in order to put data into a consistent structure, format, type, or form in order to merge data received from different channels into a common, consistent form that may be processed by other elements of ingestion pipeline module 112.

In some examples, data transferred from source collectors 132-136 may be input to interaction unification module 138, which may also be implemented with various components and elements that are configured to perform functions and data operations such as source and core field definition (i.e., user-defined definition and configuration of data field attributes, as opposed to “attributes” of received interaction data sets that are system-determined by initial parsing performed by source collectors 132-136 (FIG. 1A)), unification mapping (i.e., mapping interaction data set components to transform source data into core data formats), user interface (UI) display configuration, analytic and query configuration (i.e., enables control of fields that are to be exposed to analytic visualization and API query features), query configuration, among others. Here, interaction unification module 138 receives data from source collectors 132-136 and, in some examples, identified source and core field definitions in order to understand the layout, structure, form, format, schema, and/or type of data input to ingestion pipeline module 112. Media data containers (not shown) are identified by source collectors 132-136, which then extract data containers (not shown) from the media data containers interactions. In some examples, an interaction may be an event or transaction in which data, regardless of form, format, type, or structure (e.g., digital, analog), is exchanged or sent from one computing device to another. As an example, a mobile computing device (e.g., smartphone) may be sending data regarding a product return or refund to another computing device at a customer contact or support center. The data exchanged between these endpoints as it relates to a singular item, event, or transaction may be identified and categorized as a “transaction.” In some examples, multiple data exchanges may be identified for a given transaction where each individual data exchange may be classified as a “sub-atomic interaction.” Likewise, where common elements are found amongst sub-atomic interactions, these may be grouped together in sets or “data cohorts” (i.e., data aggregated together based on a common characteristic or set of characteristics (or attributes) and which may be further processed as described herein).

As described herein, once source field and core field definitions are identified and applied to ingested data, regardless of the type of channel from which ingested data is received, unification mapping may be performed by mapping data based on identified attributes (i.e., of the ingested data) and data attributes (i.e., further attributes yielded by processing of source collectors 132-136), into data cohorts or sets based on common characteristics. In some examples, UI displays for users of omnichannel data analysis engine 102 may also be automatically configured by analyzing the results of unification mapping of data. Further, once data is mapped into a known topology, structure, or schema, unified data may be configured for queries using one or more types of query languages to run against stored data in one or more of transcript data store 114, application datastore 116, and/or reporting datastore 118, as described below in greater detail.

In some examples, after data is processed by interaction unification module 138, interaction data enrichment module 140 may be configured to perform various functions such as, but not limited to, automated speech recognition (hereafter “ASR”), AI language classification (i.e., classifying data by identifying languages using analytical algorithms such as AI-related techniques like machine learning algorithms, deep learning algorithms, neural networks, and the like), rule-based topic classification (i.e., using templates and unique configurations to identify and tag phrases in an interaction to a topic of interaction classification), AI language clustering (i.e., using the techniques described above, clustering data together based on like terms in close proximity to each other), sentiment classification (i.e., using deep learning algorithms or rules-based classifications, positive, negative, or neutral opinions can be parsed, analyzed, and identified from interaction data sets), AI transcript summarization (e.g., identify important sentences in a transcript of an interaction using machine learning, deep learning, neural network, or AI-related algorithms to cluster and score sentences), payment card industry (PCI) data redaction (i.e., removing PCI-categorized data to prevent inadvertent exposure of sensitive financial information), and others. In other examples, ingestion system 130 and the elements shown and described may be varied in structure, function, design, layout, order, quantity, size, shape, configuration, and implementation and are not limited to those presented, which are provided for purposes of exemplary description.

FIG. 1C illustrates an exemplary analytics/AI pipeline module for omnichannel data analysis. Here, analytics/AI system 150 is shown with transcript datastore 114, application datastore 116, analytics/AI pipeline module 120, insight distribution module 124, analytics/AI ingestion module 152, analytics/AI creation module 154, insight analysis module 156, analytics/AI datastore 158, and export API 159. As used herein and in this Detailed Description, all described elements, components, and modules may be implemented, like all other elements described herein, as a software module, computer program or application, using various architectures, topologies, programming languages, and formats, without restriction or limitation. In some examples, analytics AI ingestion module 152 receives data from transcript datastore 114 and application datastore 116 and may be configured to implement various functions and data operations such as change data capture trigger (i.e., detecting a signal or data indicating a change in data stored in one or more of transcript datastore 114 or application datastore 116 have been changed), change collector (i.e., collecting and storing in, for example, transcript datastore 114, application datastore 116, or analytics/AI datastore 158, changes to stored data in interactions, sub-atomic, atomic, or otherwise), data change mapper (i.e., mapping detected changes to data between an initial, originally stored version or copy of data and a subsequently changed version or copy of data), schema service (i.e., a service that may be “called” in order to gather information, data, configuration, specification, and requirements for storing data of a given data schema), and data persister (i.e., persisting data in transcript datastore 114, application datastore 116, analytics/AI datastore 158, or others, for a given, set, determined, or specified period of time after which data may be moved, deleted, overwritten, or the like), among others before storing output data from analytics/AI ingestion module 152 to analytics/AI datastore 158.

As shown, analytics/AI creation module 154 may be implemented, configured, and designed to perform functions and data operations such as extracting data cohorts from analytics/AI datastore 158, applying data models that may be retrieved and applied from analytics/AI datastore 158, and generating output datasets from analytics/AI pipeline module 120. Output datasets from analytics/AI pipeline module 120 may be, in some examples, output for storage in analytics/AI datastore 158 or, in other examples, output to insight distribution module 124. Here, analytics/AI creation module 154 may be configured to retrieve initial data to be used to generate insights by analytics/AI pipeline module 120. For example, data cohorts stored in analytics/AI datastore 158 may be retrieved by analytics/AI creation module 154. Further, extracting a data model from analytics/AI creation module 154 may be used to process extracted data cohorts prior to being output to export API 159 for subsequent rendering or display on a user interface, as described in further detail below.

In other examples, insight analysis module 156 may be configured, designed, and implemented to retrieve (e.g., query) data from analytics/AI datastore 158 to perform functions and data operations to generate insights such as trend detection, metric calculation, anomaly (e.g., statistical outlier analysis) detection, insight valuation, pattern alerting, alerting. As shown, trend detection may be performed by insight analysis module 156 to identify statistical, heuristic, semantic, or any other type of trend in data analyzed. For example, a given product or service problem may be identified as a pattern under a given circumstance or set of circumstances as determined by analyzing a data cohort containing sub-atomic interactions (e.g., an individual customer interaction over social media) associated with a particular atomic interaction (e.g., a group of customer interactions occurring over the same or similar social media channels). Metric calculation, in some examples, may be performed by insight analysis module 156 to measure and identify individual metrics found in particular data cohorts or sets. As used throughout this detailed description, a data cohort may be a data set grouped, logically or otherwise, together based on a common characteristic, attribute, or data attribute. Metric calculation may be performed on any type of metric, without limitation or restriction and may be manually, automatically, or semi-automatically determined by omnichannel data analysis engine 102 (FIG. 1A). Likewise, patterns may also be identified by analysis performed by insight analysis module 156 and, in some examples, alerts may be generated that are output to export API 159, which may result in a visual, audible, multimedia, or any other type of alert to client computing device such as a desktop, laptop, tablet, mobile phone, smart phone, or mobile computer being used as a client in data communication with omnichannel data analysis engine 102 (FIG. 1A).

Referring back to FIG. 1C, insight valuation may also be performed by insight analysis module 156 by using, as an input, cost data associated with a given interaction, sub-atomic or atomic, in order to determine the value of a given action taken in response to an analyzed, output insight. For example, insight analysis module 156 may query and analyze data from analytics/AI datastore 158 to determine that a $5 gift certificate offered in response to a given type of problem may result in a resolution that occurs within a time range, which can be modified to increase the number of problems solved in a customer contact center. Many other examples may be envisioned in which insight valuation can be performed by analyzing data using omnichannel data analysis techniques such as those described throughout this Detailed Description, in addition to the provided description for insight analysis module 156. In other examples, omnichannel data analysis system 100 and the elements shown and described may be varied in structure, function, design, layout, order, quantity, size, shape, configuration, and implementation and are not limited to those presented, which are provided for purposes of exemplary description.

FIG. 1D illustrates an exemplary user interface module for omnichannel data analysis. Here, system 160 includes application datastore 116, reporting datastore 118, user interface module 122, insights module 162, discovery module 164, and reports module 166. In some examples, user interface module 122 may receive input data from data pipeline module 110 (e.g., application datastore 116, reporting datastore 118). Input received from application datastore 116, for example, may be input to insights module 162 and discovery module 164. In some examples, insights module 162 may be configured to perform functions and data operations to implement custom, dynamic, scoring “dashboards” (e.g., unique, custom, dynamic user interfaces that are configured to provide insights, data, and information associated with a given business, enterprise, or organization such as BXS™ or the Brand Experience Score as developed by Khoros, LLC of Austin, Tex.), time series comparisons, insight tracking dashboards, identifying emerging topics, determining contact frequency (i.e., contact frequency between an omnichannel customer contact center a given customer or customer profile), or following a given interaction (i.e., a “customer journey”), and others, without limitation or restriction.

Similarly, discovery module 164 may be configured to receive (i.e., receive input or responsive data to a query) data from application datastore 116 such as data analyzed by other modules of data pipeline module 110 (FIG. 1A). Data input to discovery module 164 may be used to perform functions and operations such as building data cohorts, performing significant term analysis, visual searching, and bookmarking. Further, reports modules 166 receives or retrieves data from reporting datastore 118 (FIG. 1A), which is used to generate reports that may be presented in any type of form, format, style, or structure, without restriction or limitation. In other examples, system 160 and the elements shown and described may be varied in structure, function, design, layout, order, quantity, size, shape, configuration, and implementation and are not limited to those presented, which are provided for purposes of exemplary description.

FIG. 1E illustrates an exemplary insight distribution module for omnichannel data analysis. Here, system 170 includes application datastore 116, insight distribution module 124, export API 159, discovery module 164, reports module 166, mobile insights module 174, and browser exports module 176. In some examples, insight distribution module 124 may be configured to transmit, transfer, render, or display insights generated by omnichannel data analysis engine 102 (FIG. 1A). As shown, export API 159 may be configured, designed, and implemented to provide functions and data operations such as a representational state transfer (e.g., RESTful) API (not shown), bookmark export, and insight export. In other words, export API 159 may be configured to export bookmarks, insights, or data (e.g., using RESTful) from omnichannel data analysis engine 102 (FIG. 1A) to external systems, devices, clients, nodes, or other computing elements.

Mobile insights module 174, in some examples, may be configured to receive data from application data store 116 (or other elements of omnichannel data analysis engine 102 (FIG. 1A)) to generate a scoring dashboard (e.g., BXS™ from Khoros, LLC of Austin, Tex.), insight tracking dashboard, insight mobile alerting, among others, without restriction or limitation. As used herein and throughout this Detailed Description, a “dashboard” may be a user interface that is configured to render and display data for a given business, enterprise, organization, department, division, or any other unit or sub-unit thereof. Here, mobile computing devices such as smartphones, tablets, data-capable cell phones, and mobile phones may receive data from mobile insights module 174 providing mobile access to insights and data of a given business, enterprise, or organization, as described above. In some examples, browser exports modules 176 may be configured to implement functions and data operations for static data export and visualization export to Internet and web browsers such as those found on a desktop, laptop, or other computing device (including mobile devices). In other examples, omnichannel data analysis system 170 and the elements shown and described may be varied in structure, function, design, layout, order, quantity, size, shape, configuration, and implementation and are not limited to those presented, which are provided for purposes of exemplary description.

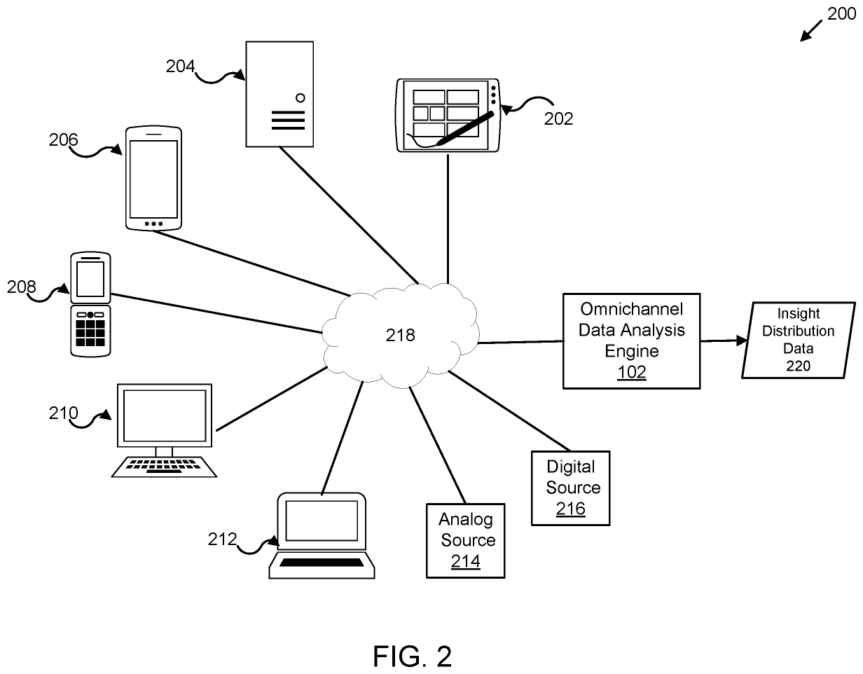

FIG. 2 illustrates an exemplary system topology for omnichannel data analysis. Here, topology 200 shows various computing devices representative of different types of communication channels that may be sources of input data (e.g., analog, digital, or binary) to omnichannel data analysis engine 102 (FIG. 1A), including tablet computer 202, server 204, smart phone 206, cell phone 208, desktop 210, laptop 212, analog source 214, and digital source 216. Data may be input to network 218, which may be representative of one or more data networks of any type of topology including, but not limited to, local area networks (LAN), wide area networks (WAN), municipal area networks (MAN), and others, without limitation or restriction. Once received by omnichannel data analysis engine 102 (FIG. 1A), data analysis, processing, and other techniques such as those described herein may be performed prior to generating output data as insight distribution data 220. In some examples, insight distribution data may be output data from insight distribution module 124 (FIG. 1E). In other examples, topology 200 and the elements shown and described may be varied in structure, function, design, layout, order, quantity, size, shape, configuration, and implementation and are not limited to those presented, which are provided for purposes of exemplary description.

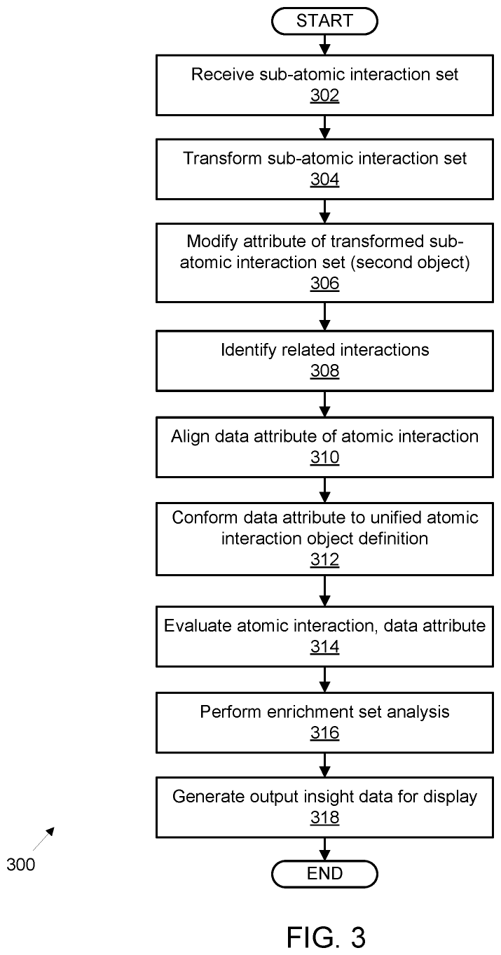

FIG. 3 illustrates an exemplary process for omnichannel data analysis. Here, process 300 begins by receiving a sub-atomic interaction set at omnichannel data analysis engine 102 (FIG. 1A) using, as described above, one or more APIs (e.g., ingestion API 104 (FIG. 1A), external API 106 (FIG. 1A), upload application/service 108 (FIG. 1A) (302). In some examples, a “sub-atomic interaction set” may refer to the smallest data transaction that occurs in an exchange between a customer and a customer contact or support system using omnichannel data analysis engine 102 (FIG. 1A). Next, the received sub-atomic interaction set(s) are transformed, which may be performed using one or more business rules (304). In some examples, a sub-atomic interaction set may be transformed from one object form, format, language, style, or structure to another (i.e., a second) form, format, language, style, or structure. Once transformed, a sub-atomic interaction set is analyzed to identify one or more attributes, which may be modified (306). After modifying an attribute or set of attributes for a transformed sub-atomic interaction set, related interactions are identified to be used in creating one or more data cohorts (308). In some examples, identifying related interactions are grouped together into an “atomic interaction” based on common attributes and used to create a data cohort that may be analyzed and processed by omnichannel data analysis engine 102 (FIG. 1A).

In some examples, once generated, an atomic interaction may have various data attributes aligned to ensure consistency and minimize errors when processing and analyzing is later performed by other elements of omnichannel data analysis engine 102 (FIG. 1A) (310). Next, data attributes are conformed to a uniformed atomic interaction object definition, which identifies the structure and rules governing conformance of data attributes to each other, data storage schemas, and processing requirements for various elements of omnichannel data analysis engine 102 (FIG. 1A) such as interaction unification module 138 (FIG. 1B) (312). Once data attributes of atomic interact sets have been aligned and conformed by ingestion pipeline module 112 (FIG. 1A), analysis is performed on the atomic interaction data sets and data attributes thereof by source collectors 132-136 (FIG. 1B) and interaction unification module 138 (FIG. 1B) (314). Subsequently, data enrichment is then performed by interaction data enrichment module 140 (316). After analysis by analytics/AI pipeline module 120 and user interface module 122 is performed and sent to insight distribution module 124, insight data is then generated and output to various endpoints for rendering and display of insight and display data. In other examples, process 300 and the elements shown and described may be varied in structure, function, design, layout, order, quantity, size, shape, configuration, and implementation and are not limited to those presented, which are provided for purposes of exemplary description.

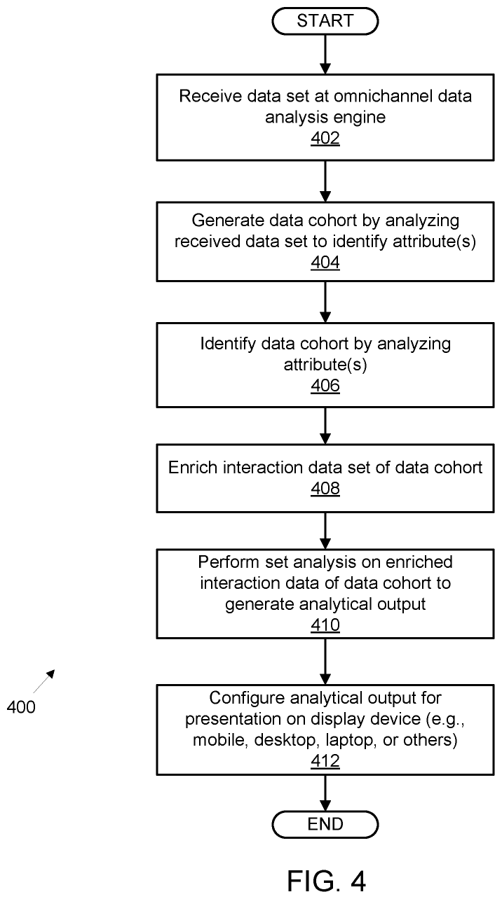

FIG. 4 illustrates another exemplary process for omnichannel data analysis. Here, process 400 begins when a data set is receiving by omnichannel data analysis engine (e.g., omnichannel data analysis engine 102 (FIG. 1A)) (402). Next, a data cohort is generated from multiple data sets being received and omnichannel data analysis being performed to identify one or more attributes associated with the data sets (404). Using the identified attributes, data cohorts are generated and analyzed (406). Next, the interaction data set undergoes enrichment to generate an enriched interaction data set (408). After generating an enriched interaction data set, set analysis is performed to generate an analytical output (e.g., insight) (410). After generating the analytical output (e.g., insight), it may be configured for export, rendering, presentation, and/or display on a dashboard or display of any type of computing device in data communication with omnichannel data analysis engine 102 (FIG. 1A) (412).

In other examples, omnichannel data analysis system 100 and the elements shown and described may be varied in structure, function, design, layout, order, quantity, size, shape, configuration, and implementation and are not limited to those presented, which are provided for purposes of exemplary description.

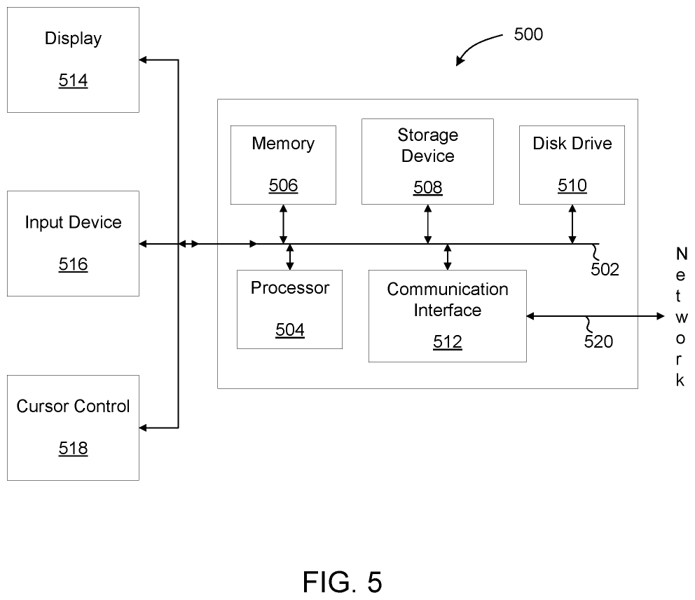

FIG. 5 illustrates an exemplary computing system suitable for omnichannel data analysis. Here, system 500 illustrates an exemplary computing system suitable for data-drive requirement analysis and matching. In some examples, computer system 500 may be used to implement computer programs, applications, methods, processes, or other software to perform the above-described techniques. Computing system 500 includes a bus 502 or other communication mechanism for communicating information, which interconnects subsystems and devices, such as processor 504, system memory 506 (e.g., RAM), storage device 508 (e.g., ROM), disk drive 510 (e.g., magnetic or optical), communication interface 512 (e.g., modem or Ethernet card), display 514 (e.g., CRT or LCD), input device 516 (e.g., keyboard), cursor control 518 (e.g., mouse or trackball), communication link 520, and network 522.

According to some examples, computing system 500 performs specific operations by processor 504 executing one or more sequences of one or more instructions stored in system memory 506. Such instructions may be read into system memory 506 from another computer readable medium, such as static storage device 508 or disk drive 510. In some examples, hard-wired circuitry may be used in place of or in combination with software instructions for implementation.

The term “computer readable medium” refers to any tangible medium that participates in providing instructions to processor 504 for execution. Such a medium may take many forms, including but not limited to, non-volatile media and volatile media. Non-volatile media includes, for example, optical or magnetic disks, such as disk drive 510. Volatile media includes dynamic memory, such as system memory 506.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 502 for transmitting a computer data signal.

In some examples, execution of the sequences of instructions may be performed by a single computer system 500. According to some examples, two or more computing system 500 coupled by communication link 520 (e.g., LAN, PSTN, or wireless network) may perform the sequence of instructions in coordination with one another. Computing system 500 may transmit and receive messages, data, and instructions, including program, i.e., application code, through communication link 520 and communication interface 512. Received program code may be executed by processor 504 as it is received, and/or stored in disk drive 510, or other non-volatile storage for later execution. In other examples, the above-described techniques may be implemented differently in design, function, and/or structure and are not intended to be limited to the examples described and/or shown in the drawings.

Although the foregoing examples have been described in some detail for purposes of clarity of understanding, the above-described techniques are not limited to the details provided. There are many alternative ways of implementing the above-described invention techniques. The disclosed examples are illustrative and not restrictive.

What is claimed:

1. A method, comprising:
receiving a sub-atomic interaction set at an omnichannel data analysis engine from a client computing device;
transforming the sub-atomic interaction set from a first object to a second object, the second object being associated with a data cohort;
modifying an attribute associated with the second object to configure the second object to be used in sub-atomic interaction convergence;
identifying a plurality of related interactions from the sub-atomic interaction set, the plurality of related interactions being combined into an atomic interaction associated with the second object;
aligning a data attribute parsed from the atomic interaction to identify one or more interaction attributes from one or more data channels monitored by the omnichannel data analysis engine, the one or more interaction attributes being assigned a common name;
configuring the data attribute to conform to a unified atomic interaction object definition;
evaluating the atomic interaction and the data attribute, after being configured to conform to the unified atomic interaction object definition, to extract a portion of the second object, the portion being used to derive another attribute;
performing enrichment set analysis on the second object and the data cohort using at least the another attribute; and
generating an output of the enrichment set analysis of the data cohort, the output being configured to be displayed on one or more interfaces.

2. The method of claim 1, wherein the first object is a client sub-atomic interaction set.

3. The method of claim 1, wherein the second object is a converted sub-atomic interaction set.

4. The method of claim 1, wherein the first object and the second object are associated with an interaction on a media platform.

5. The method of claim 1, wherein the transforming the sub-atomic interaction set from the first object to the second object further comprises converting the sub-atomic interaction set by identifying a defined sub-atomic interaction set to be associated with the sub-atomic interaction set.

6. The method of claim 1, wherein modifying the attribute further comprises parsing the attribute to identify one or more data elements to the second object.

7. The method of claim 1, wherein modifying the attribute further comprises determining an information derivative included within the sub-atomic interaction set.

8. The method of claim 1, wherein the omnichannel data analysis engine comprises a data pipeline.

9. The method of claim 1, wherein the omnichannel data analysis engine comprises a data ingestion pipeline.

10. The method of claim 1, wherein the omnichannel data analysis engine comprises a data analytics pipeline.

11. The method of claim 1, wherein the atomic interaction is stored in the second object.

12. The method of claim 1, wherein the atomic interaction comprises a data transaction between the computing device and another computing device, the data transaction having a beginning data event and an end data event.

13. The method of claim 1, wherein the sub-atomic interaction set comprises an omnichannel data interaction.

14. The method of claim 1, wherein the sub-atomic interaction set comprises digital data.

15. The method of claim 1, wherein the sub-atomic interaction set comprises an audio signal configured to be analyzed to generate digital data.

16. A method, comprising:
receiving an interaction data set from a computing device at an omnichannel data analysis engine;
generating a data cohort to be isolated from another data cohort by analyzing the interaction data set to identify one or more attributes;
identifying the data cohort by analyzing the one or more attributes enriching the interaction data set of the data cohort to generate an enriched interaction data set;
performing set analysis on the enriched interaction data set data cohort to generate an analytical output; and
configured the analytical output to be displayed on an interface in data communication with the omnichannel data analysis engine.

17. The method of claim 16, wherein the interaction data set comprises digital data from a social media network.

18. The method of claim 16, wherein the interaction data set comprises an analog signal configured to be transformed into digital data when the data cohort is generated.

19. The method of claim 16, wherein performing the set analysis on the enriched interaction data set comprises using ingested data in a guidance pipeline associated with the omnichannel data analysis engine.

20. A non-transitory computer readable medium having one or more computer program instructions configured to perform a method, the method comprising:
receiving a sub-atomic interaction set at an omnichannel data analysis engine from a client computing device;
transforming the sub-atomic interaction set from a first object to a second object, the second object being associated with a data cohort;
modifying an attribute associated with the second object to configure the second object to be used in sub-atomic interaction convergence;
identifying a plurality of related interactions from the sub-atomic interaction set, the plurality of related interactions being combined into an atomic interaction associated with the second object;
aligning a data attribute parsed from the atomic interaction to identify one or more interaction attributes from one or more data channels monitored by the omnichannel data analysis engine, the one or more interaction attributes being assigned a common name;
configuring the data attribute to conform to a unified atomic interaction object definition;
evaluating the atomic interaction and the data attribute, after being configured to conform to the unified atomic interaction object definition, to extract a portion of the second object, the portion being used to derive another attribute;
performing enrichment set analysis on the second object and the data cohort using at least the another attribute; and
generating an output of the enrichment set analysis of the data cohort, the output being configured to be displayed on one or more interfaces.
